(19) United States
(12) Patent Application Publication
(10) Pub. No.: US 2005/0232582 A1
(43) Pub. Date: Oct. 20, 2005

(54) Content data reproducing apparatus, content data reproducing system and content data reproducing program

(75) Inventor: Kazuya Miyamoto, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/091,716

(22) Filed: Mar. 29, 2005

(30) Foreign Application Priority Data
Mar. 30, 2004 (JP) P2004-101112

(51) Int. Cl. H04N 5/781

(52) U.S. Cl. 386/46; 386/125

(57) ABSTRACT

A content data reproducing apparatus including: a reproducing device acquiring the content data with plural unit data arranged in time series from a recording medium and reproduce the content data; an identification device identifying a recording medium to be reproduced, based on at least selected one of the first and last recording addresses of predetermined unit data in the recording medium at the time of reproducing the content data; an acquisition device acquiring the setting information for reproduction of the content data; and a holding device holding the acquired setting information with the corresponding recording address for the recording medium, wherein the reproducing device acquires the setting information corresponding to the recording medium from the holding device based on the identification result at the time of the second and subsequent reproduction sessions of the content data, and reproduces the content data based on the setting information.

### BACKGROUND OF THE INVENTION

1. Field of the Invention

The present invention relates to a content data reproducing apparatus capable of setting the image quality and the sound quality, or in particular to a technique for changing the setting.

2. Description of the Related Art

In recent years, the functions of the content data reproducing apparatuses such as a DVD recorder and an AV (audio-visual) amplifier have been improved to such a degree that a content data reproducing apparatus is now available having the function to set a great variety of parameters for movie subtitles, audio channel number (“channel” is hereinafter referred to as “ch”) and the sound volume In this type of content data reproducing apparatus, the parameters set by the user are held, and the contents data recorded in the recording medium or media (hereinafter referred to simply as the “medium” or “media”) such as DVD are reproduced based on the parameters thus held. In this way, the function of reproducing the content data is realized with the setting conforming with the individual user taste.

The content data are recorded in the media of various genres, and therefore the setting content conforming with the user taste is expected to vary from one content data to another. In reproducing the content data corresponding to an action movie, for example, some users may desire to set the sound volume at a large level to realize the presence, while other users reproducing the content data corresponding to a romantic movie may desire to keep the sound volume at a limited level. In order to reproduce the content data in a way reflecting the user taste, therefore, the parameter setting described above is required to be changed with the contents.

The conventional content data reproducing apparatus, however, employs a configuration to hold only one parameter corresponding to the setting content An attempt to change the parameter setting for each content, therefore, requires the very complicated job of resetting each time of medium reproduction. Especially, in the present content data reproducing apparatus in which the setting content is subdivided into details, the resetting is conspicuously complicated.

In view of this, an apparatus has been proposed in which the parameters for the dubbing sound and the subtitles are set for each medium, and the parameters thus set are recorded with (a) the corresponding total time of the content data recorded in the particular medium and (b) the corresponding BCA (burst cutting area) data for the particular medium. Also, at the time of reproduction of the content data, the medium is identified based on the BCA data and the like and the dubbing sound is reset based on the parameters corresponding to each medium as in Japanese Unexamined Patent Publication No. 2001-006330.

In the above-mentioned method of identifying the medium based on the total reproduction time, however, the medium having recorded therein the content data such as a series of drama having the same reproduction time cannot be identified.

In the method of identifying the medium using the BCA data, on the other hand, the medium can be positively identified without being affected by the specific content data recorded. Nevertheless, the BCA data are inserted as an option in the DVD data format after all and the medium with no BCA data recorded therein cannot be identified.

### SUMMARY OF THE INVENTION

This invention has been developed in view of the situation described above, and the object thereof is to provide a content data reproducing apparatus, a content data reproducing system and a content data reproducing program in which the complicated resetting of various reproduction parameters is eliminated while at the same time making it possible to positively identify each recording medium.

In order to achieve this object, according to the first aspect of the present invention, there is provided a content data reproducing apparatus comprising:
a reproducing device which acquires the content data with a plurality of unit data arranged in time series from a recording medium and reproduce the content data;
an identification device which identifies a recording medium to be reproduced, based on at least selected one of the first and last recording addresses of predetermined unit data in the recording medium at the time of reproducing the content data;
an acquisition device which acquires the setting information for reproduction of the content data; and
a holding device which holds the acquired setting information with the corresponding recording address for the recording medium; wherein
the reproducing device acquires the setting information corresponding to the recording medium from the holding device based on the identification result in the identification device at the time of the second and subsequent reproduction sessions of the content data, and reproduces the content data based on the setting information.

According to the second aspect of the present invention, there is provided a content data reproducing apparatus according to the first aspect, wherein
the acquisition device acquires the setting information corresponding to the setting content for at least selected one of sound quality and image quality at the time of reproducing the content data.

According to the third aspect of the present invention, there is provided a content data reproducing apparatus according to the first aspect, further includes:
a setting changing device which changes the setting for reproduction of an external equipment based on the setting information at the time of reproducing the content data; and
an output device which outputs the content data to be reproduced to the external equipment.

According to the fourth aspect of the present invention, there is provided a content data reproducing apparatus according to the first aspect, wherein the holding device holds a plurality of setting information indicating different setting contents with the corresponding recording addresses, and wherein
the reproducing device acquires one setting information designated by the user and reproduces the content data based on the setting information in the case where a plurality of setting information are held as data corresponding to the recording addresses.

According to the fifth aspect of the present invention, there is provided a content data reproducing apparatus according to the first aspect, wherein
the acquisition device acquires the setting information including at least the time zone during which the setting information is to be used, and wherein
the reproducing device compares the reproduction time with the time zone included in the setting information recorded with a corresponding recording address, and in the case where the reproduction time is included in the time zone, the content data is reproduced based on the setting information.

According to the sixth aspect of the present invention, there is provided a content data reproducing system comprising a content data reproducing apparatus which acquires the content data with a plurality of unit data arranged in time series from a recording medium and reproduce the content data, and an external equipment connected to the content data reproducing apparatus, the content data reproducing apparatus including:
a reproducing device which reproduces the content data;
an identification device which identifies a recording medium to be reproduced, based on at least selected one of the first and last recording addresses of predetermined unit data in the recording medium at the time of reproducing the content data;
an acquisition device which acquires the setting information for reproduction of the content data; and
a holding device which holds the acquired setting information with the corresponding recording address for the recording medium; wherein
the reproducing device acquires the setting information corresponding to the recording medium from the holding device based on the identification result in the identification device at the time of the second and subsequent reproduction sessions of the content data, and reproduces the content data based on the setting information while at the same time changing the setting for reproduction of the external equipment based on the setting information.

According to the seventh aspect of the present invention, there is provided a content data reproducing program readably recorded in a medium or a computer, the content data program is executed by a computer to acquire the content data with a plurality of unit data arranged in time series from a recording medium and reproduce the content data, the program demonstrating function comprising steps of:
identifying a recording medium to be reproduced, based on at least selected one of the first and last recording addresses of predetermined unit data in the recording medium at the time of reproducing the content data;
acquiring the setting information for reproduction of the content data;
holding the acquired setting information with the corresponding recording address for the recording medium; and
acquiring the setting information corresponding to the recording medium based on the identification result the time of the second and subsequent reproduction sessions of the content data, and reproducing the content data based on the setting information.

### BRIEF DESCRIPTION OF THE DRAWINGS

FIG. 1 is a block diagram showing a configuration of a content data reproducing system according to a first embodiment of the invention.

FIG. 2 is a diagram showing the data format of the conventional DVD video disk.

FIG. 3 is a diagram showing the data format of the conventional DVD video disk.

FIG. 4 is a diagram showing an example of recording operation in a recording unit 6 according to the same embodiment.

FIG. 5 is a diagram showing an example of the recording contents in a setting content file according to the same embodiment.

FIG. 6 is a flowchart showing the specific process of determining the setting content file executed by a system control unit 5 of a content data reproducing apparatus A according to the same embodiment.

FIG. 7 is a flowchart showing the specific setting registration process executed by the system control unit 5 of the content data reproducing apparatus A according to the same embodiment.

FIG. 8 is a diagram showing an example of the setting screen displayed on a monitor MN according to the same embodiment.

FIG. 9 is a flowchart showing the specific setting registration process executed by the system control unit 5 of the content data reproducing apparatus A according to a second modification.

FIG. 10 is a flowchart showing the specific process executed by the system control unit 5 of the content data reproducing apparatus A according to a second embodiment of the invention.

### DESCRIPTION OF THE PREFERRED EMBODIMENTS

### [1] First Embodiment

### [1.1] Configuration of First Embodiment

(1) Outline of Content Data Reproducing System

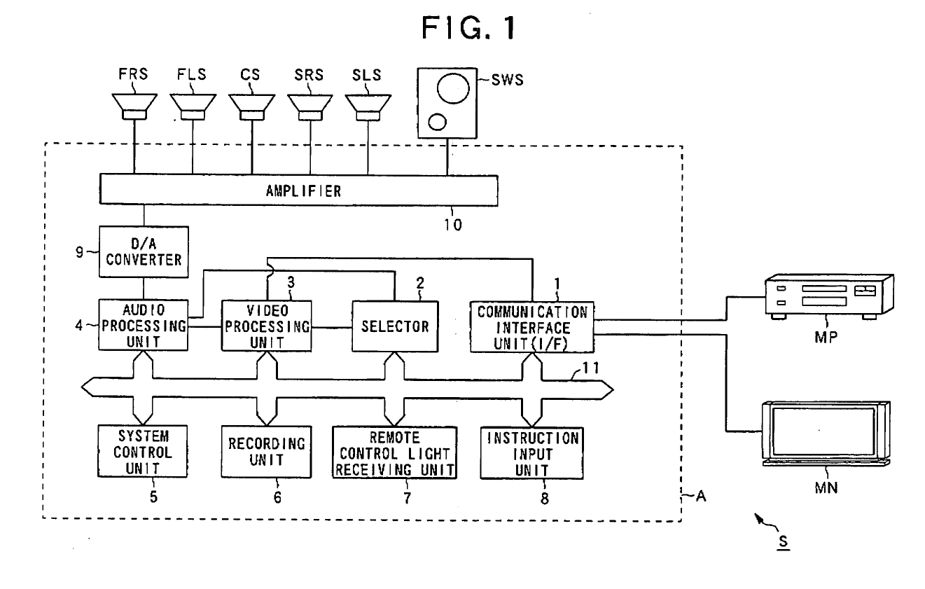

First, an outline of a content data reproducing system S according to this embodiment is explained with reference to FIG. 1 showing a configuration thereof. FIG. 1 shows an example of the configuration in which the content data reproducing apparatus A making up the content data reproducing system is an AV amplifier. This content data reproducing system S, however, is only an example of the invention, and a medium reproducing apparatus MP may be integrated with the content data reproducing apparatus A of the system or a monitor MN may be built in to make up one whole system.

As shown in FIG. 1, the content data reproducing system S according to this embodiment comprises a monitor MN to display various images, a medium reproducing apparatus MP such as a DVD recorder, a front right speaker FRS, a front left speaker FLS, a center speaker CS, a surround right speaker SRS, a surround left speaker SLS, a subwoofer SWS (hereinafter referred to simply as the speaker S as a whole unless each speaker is not required to be specified), and a content data reproducing apparatus A. The term “external equipment” in “WHAT IS CLAIMED IS” corresponds to the medium reproducing apparatus MP and the monitor MN.

In this content data reproducing system S, the content data read from a medium by the medium reproducing apparatus MP such as the DVD recorder are supplied to the content data reproducing apparatus A. The video data contained in the content data is output to the monitor MN by the content data reproducing apparatus A, while the audio data contained in the content data is processed as a signal by the content data reproducing apparatus A and then output to each speaker S. In the content data reproducing system S according to this embodiment, therefore, an image corresponding to the content data recorded in the medium is displayed on the monitor MN on the one hand and a sound corresponding to the content data is output from each speaker on the other hand.

The content data reproducing apparatus A included in the content data reproducing system S has recorded therein the parameters required for various reproduction settings such the sound volume, subtitles and the audio ch number. Once the user makes various reproduction settings, the content data reproducing apparatus A reads a parameter corresponding to the setting content from the parameters, and using the parameter thus read, changes the setting in the particular apparatus (hereinafter referred to as the local unit) on the one hand and the reproduction setting of the monitor MN and the medium reproducing apparatus MP at the same time

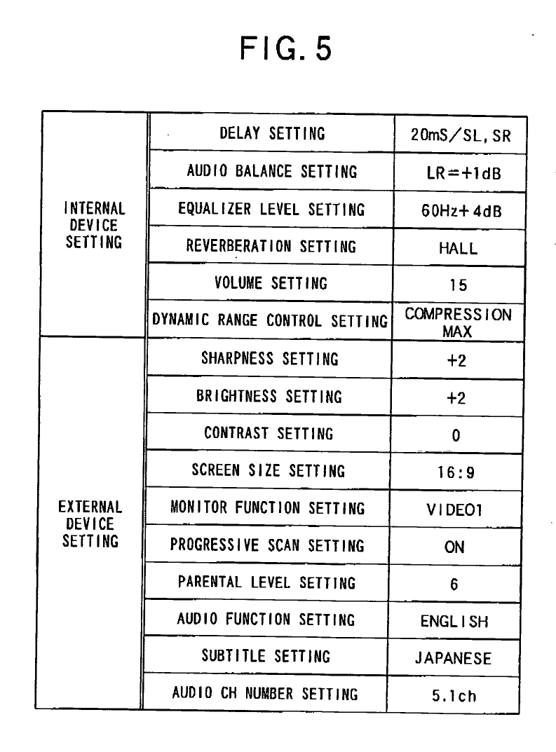

Also, the content data reproducing apparatus A, in setting these parameters, generates a setting content file describing the parameters (FIG. 5), and records the setting content file with a corresponding data (hereinafter referred to as the identification data) by which each medium can be uniquely identified. A specific configuration of the setting content file and specific parameters are described in detail later.

Upon occurrence of any of events described below, for example, the content data reproducing apparatus A searches the setting content file with the identification data as a search key.

(Event 1) A medium corresponding to the identification data is inserted in the medium reproducing apparatus MP.

(Event 2) An input operation is performed to change the setting content by the user.

In the case where the identification data are recorded with a corresponding setting content file, the content data reproducing apparatus A reads the particular setting content file, and based on the parameters described in the setting content file, changes the setting of the local unit or changes the reproduction setting of the medium reproducing apparatus MP and the monitor MN.

Due to these functions, in the content data reproducing system S according to this embodiment, the setting of each unit is changed automatically to meet the user taste using the setting content file already recorded, without resetting for reproduction of each unit on the part of the user. Incidentally, in the case where the setting content file has recorded nothing therein at the time of occurrence of any of the events described above, an arbitrary setting method can be employed According to this embodiment, however, an explanation is given on the assumption that the contents to be set are determined at default to make the description more specific.

As described above, in the case where the BCA data or the reproduction time information is used as the identification data, it may often happen that a medium cannot be identified. According to this embodiment, therefore, the content data reproducing apparatus A is configured to use, as the identification data, those of the information described positively in a medium by which the medium can be positively identified.

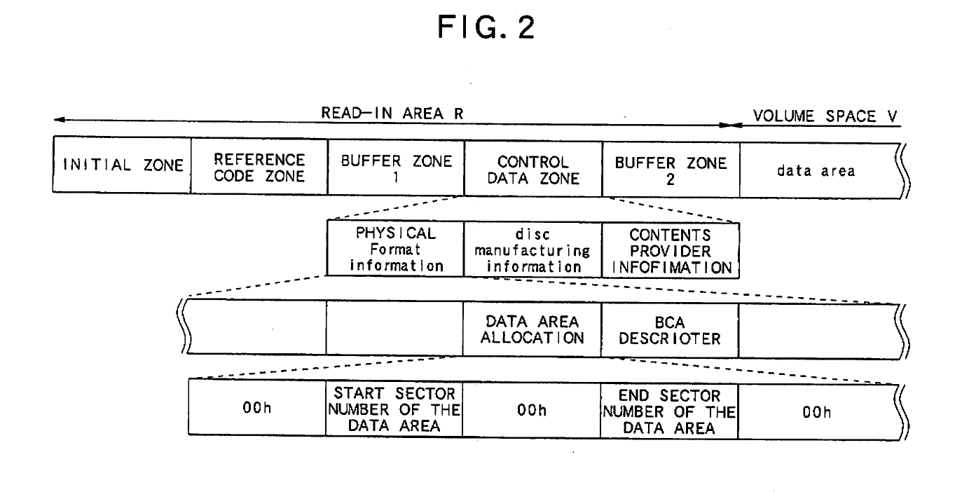

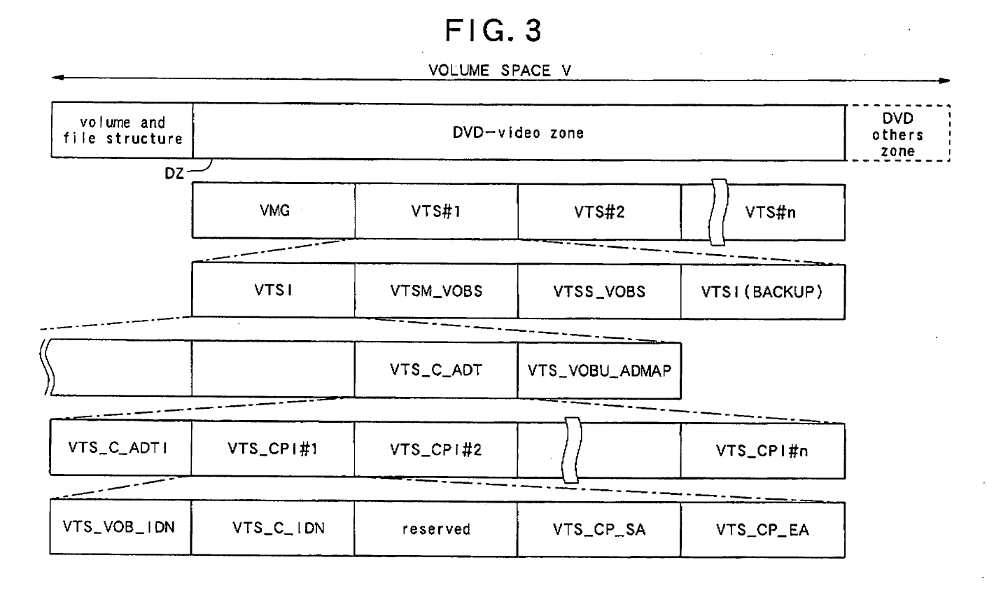

Specific contents of this identification data are explained with reference to FIGS. 2 and 3. Both FIGS. 2 and 3 show the data format of the conventional DVD video disk.

As shown in FIGS. 2 and 3, the DVD video disk is roughly divided into a read-in area R and a volume space V having a DVD video zone DZ for recording the content data. The data described in these areas are divided by sector, and serial sector numbers are attached to all the sectors The sector numbers are expressed by hexadecimal notation, and in FIGS. 2 and 3, each sector number of hexadecimal notation has a postfix “h”.

The read-in area R has an initial zone and a buffer zone each configured of a bit string of all 0s. Embedded between these zones are sectors including a reference code zone constituting a reference code sector and a control data zone constituting a control data sector. The control data zone includes the disk manufacturing information indicating the disk producer and the content provider information constituting the copyright information of the content data

The control data zone, in addition to these two information, includes the physical format information indicating the physical specification of the DVD disk, such as the DVD type (DVD-ROM, DVD-R, etc.), the disk size, the transfer rate, the disk structure (single layer, double layer, etc.), the recording density, the BCA (burst cutting area) descriptor and the data area allocation. The data area allocation is configured of the starting sector number of a data area, i.e. the volume space V (hereinafter referred to as the start sector number) and the last sector number of the volume space V (hereinafter referred to as the end sector number).

The start sector number is shared by all the DVD video disks and indicated as “0300h”. The end sector number, on the other hand, is varied with the data amount of the content data recorded in each disk and different for a different disk.

The DVD video zone DZ of the volume space V is divided into the video manager (hereinafter referred to as VMG) and a plurality of video title sets (hereinafter referred to as VTS). The VMG is a logic unit to constitute a table of contents specifying all the titles existing on the disk, and configured of the titles of the content data recorded in the disk and the image data corresponding to the menu screen, etc. to select each title.

The VTS, on the other hand, is a logic unit constituting the content data corresponding to one or a plurality of titles, and configured of the video title set information (hereinafter referred to as VTSI) and the video object set (hereinafter referred to as VOBS) describing the content data body.

The VTS includes the same data as VTSI as a backup described after VOBS. Also, the content data is divided into minimum unit data called the video object units (hereinafter referred to as VOBU) in the VOBS, and a plurality of VOBUs combine to make up one cell while a plurality of cells combine to make up a video object (hereinafter referred to as VOB).

On the other hand, the VTSI includes a title of the content data and at least one data corresponding to the title menu. At the same time, the VTSI includes a video title set cell address table (hereinafter referred to as VTS_C_ADT) and a video title set object unit address map (hereinafter referred to as VTS_VOB_ADMAP). This VTS_VOB_ADMAP is a table to store the start address and the end address of each VOBU making up the VOBS.

The VTS_C_ADT, on the other hand, is a table containing, as elements thereof, video title set cell address table information (hereinafter referred to as VTS_C_ADTI) and a plurality of video title set cell piece information #k (k: 1, 2, . . . , n) (hereinafter referred to as VTS_CPI#k) . Each VTS_CPI#k is information defining the address of each cell making up the VOBS, and configured of the ID number of the corresponding cell (hereinafter referred to as VTS_C_IDN), the ID number of the VOB associated with the particular cell (hereinafter referred to as VTS_VOB_IDN), and the start address (hereinafter referred to as VTS_CP_SA) and the end address (hereinafter referred to as VTS_CP_EA) of the cell

The VTS_CP_SA and VTS_CP_EA are varied depending on the data size of the cells into which the content data recorded in each disk are divided. Therefore, the VTS_CP_SA and VTS_CP_EA have various contents depending on the content data recorded in each disk. Also, as described above, the end sector number of the read-in area R is varied with the data amount of the content data recorded in each disk and a different disk has a different content.

Thus, each medium can be positively identified by combining the end sector number and the VTS_CP_SA and VTS_CP_EA, or by using any unit data as identification data. Any VTS_CP_SA and VTS_CP_EA can be used arbitrarily to identify the medium. For example, the VTS_CP_SA and VTS_CF_EA corresponding to the cells arranged in predetermined sequence in VTSI may be used, or the VTS_CP_SA and VTS_CP_EA corresponding to a predetermined number of cells existing between the first and last cells may be used. With the increase in the number of data used, the accuracy of medium identification is improved Desirably, therefore, the VTS_CP_SA and VTS_CP_EA corresponding to a plurality of cells are used.

(2) Specific Configuration of Content Data Reproducing Apparatus A

Next, a specific configuration of the content data reproducing apparatus A according to this embodiment having the functions described above is explained. First, as shown in FIG. 1, the content data reproducing apparatus A according to this embodiment comprises a communication interface unit 1 (the interface is hereinafter referred to as I/F), a selector 2, a video processing unit 3, an audio processing unit 4, a system control unit 5, a recording unit 6, a remote control light receiving unit 7, an instruction input unit 8, a digital/analog converter (hereinafter referred to as a D/A converter) 9, an amplifier 10 and a data bus 11 connecting these elements to each other. The “reproducing device” as described in “WHAT IS CLAIMED IS” is implemented, for example, by cooperation between the video processing unit 3, the audio processing unit 4 and the system control unit 5, and the “identification device” and the “acquisition device” correspond to the system control unit 5. Also, the “holding unit” corresponding to the recording unit 6.

The communication I/F unit 1 is, for example, IEEE (the Institute of Electrical and Electronic Engineers) 1394 or RS (Recommended Standard) -232C and has a plurality of connection terminals to connect external equipments. In the communication I/F unit 1, the data input from the external equipments through the connection terminals is output to the selector 2 and the data bus 11 on the one hand, and the data input through the data bus 11 are output to the external equipments through the connection terminals on the other hand. According to this embodiment, the connection terminals are connected to the external equipments such as the medium reproducing apparatus MP and the monitor MN. The content data reproducing apparatus A exchanges data with the medium reproducing apparatus MP and the monitor MN through the communication I/F unit 1.

The remote control light receiving unit 7 is configured of, for example, a photo detector, and receives the control signal transmitted by infrared light from a remote controller not shown, while at the same time outputting the received control signal to the data bus 11. The instruction input unit 8 includes keys and a cursor key to select the signal in the selector 2, and outputs the control signal corresponding to the user input operation to the system control unit 5 through the data bus 11.

In the video processing unit 3, the video data input from the selector 2 and the image data output from the system control nit 5 through the data bus 11 are output to the monitor MN through the communication I/F unit 1. As a result, various images corresponding to the video data contained in the content data input from the medium reproducing apparatus MP through the communication I/F unit 1 and the image data output from the system control nit 5 are displayed on the monitor MN. Incidentally, a decoder may or may not be included in the video processing unit 3 as desired, and therefore, in the case where the decoder is included in the monitor MN, the video processing unit 3 is not necessarily required to include the decoder.

The audio processing unit 4 includes a DSP (digital signal processor) and variously processes the signals of the audio data input from the selector 2 under the control of the system control unit 5, and outputs the resulting signal to the D/A converter 9. In the process, the audio processing unit 4 processes the signal differently for each audio data corresponding to each ch thereby to change the sound pressure level and the frequency characteristic of the audio data corresponding to each ch and the timing at which the sound is output from each speaker S. In the case where the audio data of 5.1 ch is input from the medium reproducing apparatus MP, for example, the audio processing unit 4 processes the signal to change the characteristics such as the sound pressure level and the output timing for each 5.1 ch.

In the D/A converter 9, the audio data corresponding to each ch of which the signal is processed by the audio processing unit 4 is D/A converted and output to the amplifier unit 10. In the description that follows, the data output from the medium reproducing apparatus MP and not yet D/A converted is called the audio data, and such data after D/A conversion is called the audio signal.

In the amplifier unit 10, the audio signal input from the D/A converter 9 is amplified and output to the speaker S. This amplifier unit 10 includes output terminals and low-frequency amplifiers in the number corresponding to the number of ch that can be output, and the audio signal corresponding to each ch input from the D/A converter 9 is output to each speaker S connected to the output terminals As a result, the audio signal corresponding to each ch D/A converted from the audio data corresponding to each ch are output independently of each other from each speaker S.

The recording unit 6 is configured of, for example, a nonvolatile memory such as EEPROM (electrically erasable programmable read-only memory), and has stored therein the information used by the system control unit 5 to execute various processes. The information recorded in the recording unit 6 also contains the various parameters required for the system control unit 5 to generate the setting content file. The specific contents of the parameters recorded in the recording unit 6 are explained in detail in the next section.

The system control unit 5 includes, for example, a ROM (read-only memory), a RAM (random access memory) and a CPU (central processing unit) to control the various parts of the audio reproducing apparatus A by executing the control program recorded in the ROM.

The system control unit 5 executes the following processes.

(a) Setting Registration Process

In this process, the parameters are set for the image quality and the sound quality in reproducing the content data recorded in the medium thereby to generate the setting content file. Specifically, once a predetermined input operation is performed on the remote controller not shown or the instruction input unit 8, the system control unit 5 executes the setting registration process, and based on the user input operation, reads the corresponding parameters from the recording unit 6. Based on the various parameters thus set, the parameters for signal processing in the local unit or the setting on the image quality and the sound quality of the monitor MN and the medium reproducing apparatus MP is changed.

Also, in this process, the system control unit 5 generates a setting content file describing the parameters corresponding to the setting contents, and records the setting content file with corresponding identification data in the recording unit 6. In the process, the system control unit 5 outputs the control signal to the medium reproducing apparatus MP and thus causes the medium reproducing apparatus MP to read the VTSI containing in a predetermined VTS and the data of the read-in area R described in the medium inserted therein. Then, the system control unit 5 extracts the required data from the data such as VTSI and thus extracts the identification data.

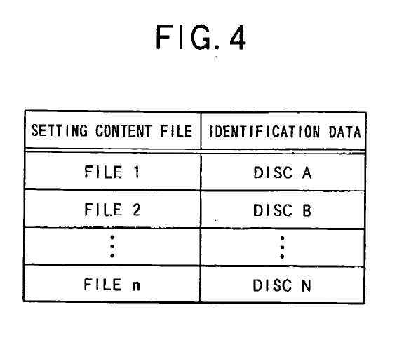

An example of recording the setting content file and the identification data in the recording unit 6 is shown in FIG. 4. As shown in FIG. 4, according to this embodiment, the recording unit 6 has recorded therein the setting content file with the corresponding identification data. The setting content file recorded in the recording unit 6 is generated while the medium corresponding to the identification data is inserted in the medium reproducing apparatus MP.

Each identification data corresponds to as many setting content files as desired. In the case where the user makes a plurality of settings for one medium, as many setting content files as the number of settings described above are recorded as data corresponding to the identification data.

(b) Setting Content File Determining Process

This process is executed by the system control unit 5 upon generation of an event like (Event 1) or (Event 2) described above In this process, the system control unit 5 acquires, from the medium reproducing apparatus MP, the identification data corresponding to the medium inserted in the medium reproducing apparatus MP. The system control unit 5 then searches the recording unit 6 with the identification data as a key, and determines whether the corresponding setting content tile is recorded or not.

In the case where it is determined that the setting content file is not recorded, the system control unit 5 sets a default parameter to process the signal in the audio processing unit 4 without changing the setting of the monitor MN and the medium reproducing apparatus MP.

In the case where it is determined that the setting content file is recorded, on the other hand, the system control unit 5 reads the setting content file and based on the various parameters described in the setting content file, changes the setting of the content data reproducing apparatus A, the medium reproducing apparatus MP and the monitor MN. At the same time, the system control unit 5 inputs the parameters described in the setting content file to the audio processing unit 4. As a result, the parameters used for signal processing in the audio processing unit 4 are changed.

There may exist in the recording unit 6 a plurality of setting content files recorded with the corresponding identification data acquired from the medium reproducing apparatus MP. In such a case, the system control unit 5 generates the image data corresponding to the screen to select the setting content files and outputs the image data to the monitor MN.

In accordance with the image displayed on the monitor MN, the user performs the input operation, through the instruction input unit 8 or the remote controller not shown, to designate the setting content file to be read. Then, the system control unit 5 reads the selected setting content file, and based on the various parameters described in the setting content file, changes the setting of the content data reproducing apparatus A and the external equipments, i.e. the medium reproducing apparatus MP and the monitor MN.

Once the setting of the content data reproducing apparatus A is changed in this way, the content data recorded in the medium in the set state is reproduced. Incidentally, the setting registration process and the setting content file determining process are specifically described in detail later.

(3) Setting Content File

With reference to FIG. 5, the setting content file generated by the content data reproducing apparatus A according to this embodiment is explained specifically. FIG. 5 shows an example of the recording contents of the setting content file.

As shown in FIG. 5, the description in the setting content file roughly contains the internal equipment setting parameters and the external equipment setting parameters. The contents of each parameter are described below.

(i) Internal Equipment Setting Parameters

The internal equipment setting parameter indicates the setting content of the content data reproducing apparatus A. An arbitrary parameter can be set in this category. FIG. 5, however, shows a case in which the following parameters are set.

<Delay Setting Parameter for Each ch>

In order to reproduce an optimum sound field by localizing the sound image at the listening point, the audio output timing is required to be changed in accordance with the distance between the listening point and each speaker S. This parameter determines the delay time for delaying an audio data corresponding to each ch in the audio processing unit 4 in accordance with the distance between the listening point and the speaker S.

<Audio Balance Setting Parameter>

Also, in order to reproduce an optimum sound field by localizing the sound image at the listening point as described above, the volume of the sound output from each speaker is required to be changed in accordance with the distance between the listening point and each speaker S. This parameter determines the volume level for changing the sound volume of the audio data corresponding to each ch in the audio processing unit 4 in accordance with such a distance.

<Equalizer Level Setting Parameter>

This parameter determines that frequency characteristic of the audio data corresponding to each ch in the audio processing unit 4 which may be changed in accordance with the distance between the listening point and each speaker S.

<Reverberation Setting Parameter>

This parameter is for adding the reverberation to the audio data for signal processing in the audio processing unit 4.

<Volume Setting Parameter>

This parameter determines the gain of the amplifier 10. Based on this parameter, the system control unit 5 changes the gain of the amplifier 10 thereby to change the volume of the sound output from the speaker 5.

<Dynamic Range Control Setting Parameter>

In an action movie, for example, even in the case where the script is set at a sound volume that can be properly heard, a sound of a volume not intended by the user may be output in the scene of an explosion, for example. This parameter determines the manner in which the audio data is compressed in the audio processing unit 4 in such a case. Specifically, the audio processing unit 4, upon receipt of the audio data having more than a predetermined volume, compresses the audio data based on this parameter to reduce the sound volume.

(ii) External Equipment Setting Parameters

The external equipment setting parameters determine the setting content of the medium reproducing apparatus MP and the monitor MN connected to the connection terminal of the communication I/F unit 1. In accordance with the external equipment setting parameters, the system control unit 5 controls the external equipments, i.e. the medium reproducing apparatus MP and the monitor MN. Specific external equipment setting parameters actually set are arbitrary, and for example, include the following.

<Sharpness Setting Parameter>

This parameter is for correcting the image contour at video output of the monitor MN.

<Brightness Setting Parameter>

This parameter is for adjusting the brightness of the whole image at video output of the monitor MN.

<Contrast Setting Parameter>

This parameter is for adjusting the luminance of the whole image at video output of the monitor MN.

<Screen Size Setting Parameter>

This parameter is for switching the aspect ratio of 3:4 or 9:16, for example, as a screen size at video output of the monitor MN.

<Monitor Function Setting Parameter>

This parameter is for example a parameter for setting a monitor function (VIDEO input).

<Progressive Scan Setting Parameter>

This parameter is for switching the on/off state of the progressive scanning of the content data in the medium reproducing apparatus MP. While this parameter is in on state, the medium reproducing apparatus MP converts between progressive and interlace scan of the content data and outputs the content data after conversion to the content data reproducing apparatus A.

<Parental Level Setting Parameter>

The DVD video disk has an optional function of determining, using a numerical value of what is called the parental level, whether the contents of a scene or a sound involving, for example, a violence or sexual behavior are proper to the viewers or not. This parameter is for determining the parental level up to which the display of a given image is allowed. Once this parameter is set, the medium reproducing apparatus MP prohibits the reproduction of an image of higher than the parental level corresponding to the particular parameter.

<Audio Function Setting Parameter>

This parameter is for determining a particular language in which to reproduce the contents data recorded in the medium which include the audio data corresponding to the languages of a plurality of nations.

<Subtitle Setting Parameter>

This parameter is used to switch on/off the subtitle display in the case where the content data recorded in the medium include subtitle data, and also to switch the subtitle to a given language in the case where the particular data include the subtitles of a plurality of languages.

<Audio ch Number Setting Parameter>

This parameter is used to change the ch number of the audio data output from the medium reproducing apparatus MP for reproducing the content data. In the case of the DVD disk, for example, there exist three patterns including “monaural”, 2 ch and 5.1 ch.

### [1.2] Operation of First Embodiment

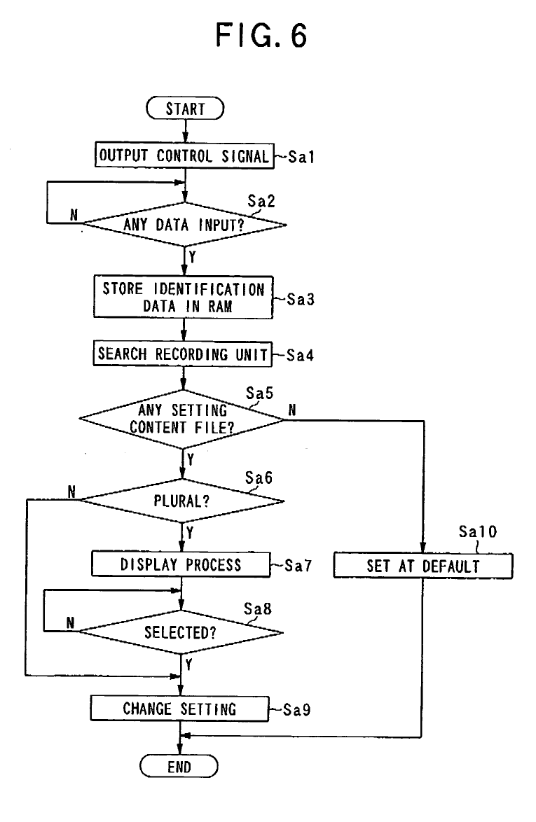

Next, the specific operation of the content data reproducing system S according to this embodiment is explained with reference to FIGS. 6 to 8. First, the setting content file determining process is explained in (1), after which the setting registration process is explained in (2).

(1) Setting content file determining process

First, assume that an event such as Event 1 or Event 2 described above occurs while the user switches on the medium reproducing apparatus MP, the monitor MN and the content data reproducing apparatus A. The system control unit 5 of the content data reproducing apparatus A executes the process shown in FIG. 6 with the particular event as a trigger. In this process, the system control unit 5 first outputs a control signal to the medium reproducing apparatus MP (step Sa1) and assumes a standby state waiting for the data input from the medium reproducing apparatus MP (NO at step Sa2).

As a result, the medium reproducing apparatus MP reads the data recorded in the read-in area R of the inserted medium and the VTSI contained in a predetermined VTS in accordance with the control signal, and outputs the data to the content data reproducing apparatus A.

Once the data is input from the medium reproducing apparatus MP in this way, the system control unit 5 of the content data reproducing apparatus A determines as YES at step Sa2, and extracts (a) the end sector number, (b) VTS_CP_SA and (c) VTS_CP_EA contained in the particular data as identification data, and write them on the RAM not shown (step Sa3). The system control unit 5 searches the recording unit 6 with this identification data as a key (step Sa4) and determines whether the setting content file corresponding to the identification data is recorded in the recording unit 6 or not (step Sa5).

In the case where the determination at step Sa5 is that the setting content file corresponding to the particular identification data is not recorded (NO at step Sa5), the system control unit 5 conducts the setting process in accordance with the default parameter without reading the setting content file (step Sa10) thereby to end the process.

In the case where the determination at step Sa5 is YES, on the other hand, the system control unit 5 determines whether the recording unit 6 has recorded therein a plurality of setting content files corresponding to the particular identification data (step Sa6). In the case where the determination at step Sa6 is NO, the system control unit 5 reads the setting content file from the recording unit 6, and changes the setting based on the particular setting content file (step Sa9) thereby to end the process. More specifically, at step Sa9, the system control unit 5 inputs the internal equipment setting parameter described in the setting content file to the audio processing unit 4, and based on the external equipment setting parameter, controls the medium reproducing apparatus MP and the monitor MN thereby to change the setting.

In the case where the determination at step Sa6 is YES, on the other hand, the system control unit 5 generates and supplies the image data to the video processing unit 3 (step Sa7) and assumes a standby state to wait for the input operation of the user (NO at step Sa8). As a result, the image data is output to the monitor MN by the video processing unit 3. Thus, the monitor MN displays the character string “A plurality of settings. Select one”, together with a list to select the setting content from. In the process, a particular list to be displayed on the monitor MN is arbitrary. For example, a list of all the contents of the parameters shown in FIG. 5 may be displayed

Under this condition, an instruction is given by the user to the input unit 8 or the remote controller to conduct the input operation to select a given setting content file. Then, the system control unit 5 determines as YES at step Sa8, and reads the selected setting content file from the recording unit 6, while at the same time changing the setting based on the setting content file (step Sa9) thereby to end the process.

As the result of executing the process described above, each unit of the content data reproducing system S is set in the contents of the parameters described in the setting content file corresponding to the medium inserted in the medium reproducing apparatus MP.

(2) Setting Registration Process

Next, the setting registration process is explained. To execute this process, what is required first is for the user to insert a medium into the medium reproducing apparatus MP and perform a predetermined input operation on the instruction input unit 8 or the remote controller. A specific input operation is arbitrary. For example, the instruction input unit and the remote controller may include a setting registration processing button which is depressed to execute the setting registration process.

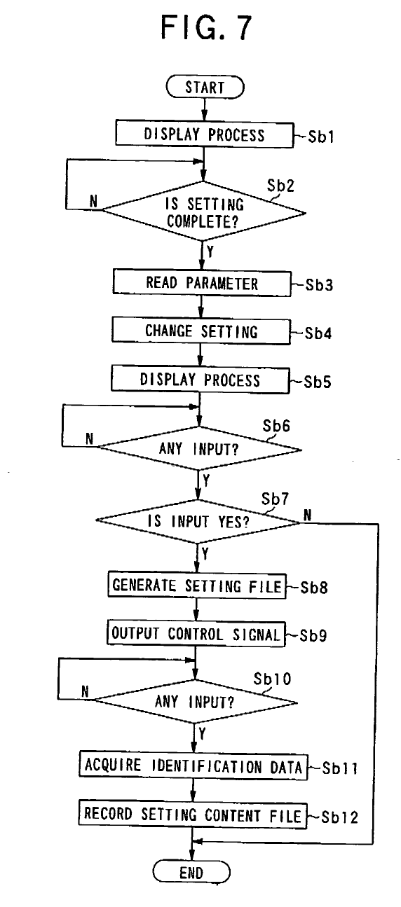

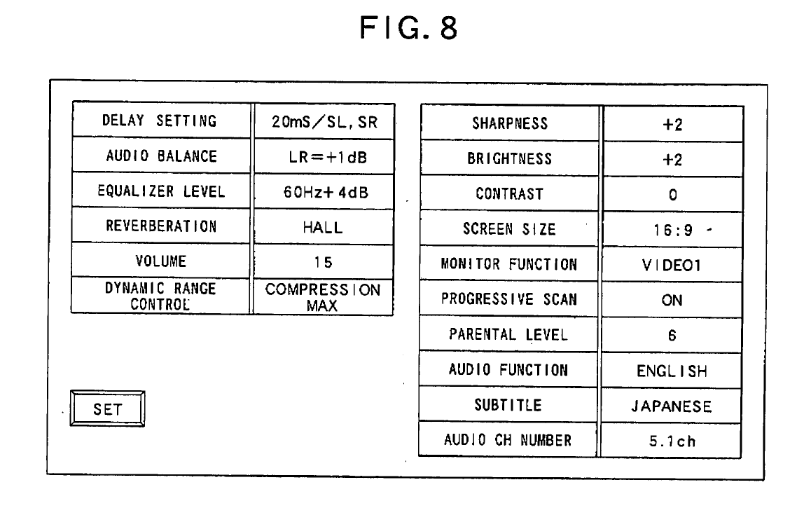

With this input operation as a trigger, the system control unit 5 starts the process shown in FIG. 7. In the process, the system control unit 5 first generates the image data and supplies it to the video processing unit 3 (step Sb1), after which it is determined whether the setting is complete or not (step Sb2). An example of the image displayed on the monitor MN is shown in FIG. 8. As shown in FIG. 8, the monitor MN displays an image to input various information required for setting the internal equipment setting parameters and the external equipment setting parameters. Also, a button “set” is displayed on the monitor MN

Under this condition, the user performs the input operation to designate the contents of each parameter and also to select the “set” button on the instruction input unit 8 or the remote controller. Then, the system control unit 5, in accordance with the particular input operation, determines as YES at step Sb2 and reads the various parameters corresponding to the setting content designated by the user (step Sb3). Thus, the setting of each unit of the content data reproducing system S is changed (step Sb4). Specifically, the system control unit 5 inputs the parameters into the audio processing unit 4 at step Sb4, while at the same time changing the setting of the medium reproducing apparatus MP and the monitor MN in accordance with the parameters.

Next, the system control unit 5 generates and supplies the image data to the video processing unit 3 (step Sb5) and assumes a standby state to wait for the user input operation (NO at step Sb6).

As a result, the monitor MN displays, for example, the character string “Store the setting content?”, together with two buttons, “YES” and “NO”. Under this condition, the user performs the input operation to select any one of the buttons. Then, the system control unit 5 determines as YES at step Sb6 and determines whether the selected button is YES (step Sb7). In the case where the user conducts the input operation to select the button “NO” on the instruction input unit 8 or the remote controller, the system control unit 5 determines as “NO” at step Sb7, and the process is ended without executing steps Sb8 to Sb12.

In the case where the user conducts the input operation on the instruction input unit 8 to select the button “YES”, on the other hand, the system control unit 5 determines as YES at step Sb7 and generates the setting content file based on the parameter read at step Sb3 (step Sb8). Upon generation of the setting content file in this way, the system control unit 5 outputs a control signal to the medium reproducing apparatus MP (step Sb9) and enters a standby state to wait for the data input from the medium reproducing apparatus MP (NO at step Sb10). As a result, the medium reproducing apparatus MP, in accordance with the control signal, the data recorded in the read-in area R of the inserted medium and the VTSI contained in a predetermined VTS and outputs them to the content data reproducing apparatus A.

Upon input of the data from the medium reproducing apparatus MP, on the other hand, the system control unit 5 of the content data reproducing apparatus A determines as YES at step Sb10, and extracts (a) the end sector number, (b) VTS_CP_SA and (c) VTS_CP_EA contained in the particular data as identification data (step Sb11), and records the identification data with the corresponding setting content file in the recording unit 6 (step Sb12) thereby to end the process.

As the result of execution of the process described above, the setting content file is generated for each identification data corresponding to each medium and recorded in the recording unit 6. Even in the case where the setting content file is already recorded in the recording unit 6, the system control unit 5 executes the process described above, so that a new setting content file is generated and added to the recording unit 6. As a result, a plurality of setting content files for one corresponding identification data are recorded in the recording unit 6.

The system control unit 5, utilizing the setting content files recorded in the recording unit 6, executes the process of determining the setting content files and changes the setting of each unit making up the content data reproducing system S by the setting content file corresponding to the medium inserted in the medium reproducing apparatus MP.

As described above, the content data reproducing apparatus A according to this embodiment, in which the content data including a plurality of unit data such as VTS or cells arranged in time series are read from the DVD or the like medium and reproduced, comprises the system control unit 5, the audio processing unit 4 and the video processing unit 3. In the system control unit 5, a setting content file describing the parameters for reproduction of the content data is generated. The identification data corresponding to, for example, the first or last recording address of a predetermined sequence of unit data such as VTS and cells making up the content data in a medium is acquired from the particular medium and recorded with a corresponding setting content file in the recording unit 6. At the same time, in reproducing the content data, the identification data is acquired from the medium having recorded therein the content data and whether the particular identification data is recorded in the recording unit 6 or not is determined in the system control unit 5. In the case where the system control unit 5 determines that the identification data is recorded in the recording unit 6, the audio processing unit 4, the system control unit 5 and the video processing unit 3 combine to reproduce the content data based on the setting content file recorded with the corresponding identification data in the recording unit 6.

In this configuration, in accordance with the user instruction, the setting content file describing the parameters for reproducing the content data is generated, and recorded in the recording unit 6 together with corresponding identification data for the first or last recording address of a predetermined sequence of unit data in the medium. In reproducing the content data, the identification data is acquired from the medium having the particular content data recorded therein, and in the case where the recording unit 6 has recorded therein an identification data identical with the identification data acquired from the medium, the content data is reproduced based on the setting content file.

In the content data reproducing apparatus A according to this embodiment, the various parameters for reproduction are automatically reset while identifying each medium. Thus, the bothersome factor in the resetting process is obviated.

Also, the content data reproducing apparatus A according to this embodiment has such a configuration that the system control unit 5, in accordance with the user instruction, generates a setting content file describing the parameters indicating the setting content including at least one of sound quality and image quality at the time of reproducing the content data. With this configuration, the various parameters indicating the setting content for at least one of sound quality and image quality are described in the setting content file. Even in the case where the resetting process is very complicated as in setting the image quality or the like in detail, therefore, the automatic resetting process obviates the bothersome factor.

Further, the content data reproducing apparatus A according to this embodiment is so configured that the system control unit 5, in reproducing the content data, changes the setting for reproduction of the medium reproducing apparatus MP and the monitor MN based on the setting content file, and the video processing unit 3 outputs the content data to be reproduced to the monitor MN. With this configuration, regardless of whether the content data reproducing apparatus A is constituted as an independent unit or the external equipments such as the medium reproducing apparatus MP are connected, the setting for reproduction of the external equipments can be changed based on the setting content file and the content data reproduced by the setting after the change.

Further, the content data reproducing apparatus A makes the recording unit 6 record a plurality of setting content files indicating various different setting contents in correspondence with identification data. In the case where the plurality of setting content files indicating various different setting contents are recorded in the recording unit 6, the system control unit 5 extracts one setting content file designated by the user and reproduces the content data based on the particular setting content file. With this configuration, a plurality of setting content files are recorded in the recording unit 6 with corresponding identification data, and of all these setting content files recorded, the content data are reproduced based on the setting content file designated by the user. As a result, the user can select the desired setting content file to his/her taste out of a plurality of setting content files corresponding to a plurality of setting contents, and can enjoy the reproduction of the content data with the setting corresponding to the particular setting content file.

According to this embodiment, instead of configuring the medium reproducing apparatus MP and the content data reproducing apparatus A as independent units, the content data reproducing apparatus A may be equipped with the medium reproducing function as a single unit.

Also, according to this embodiment, the setting content file is recorded in the recording unit 6 of the content data reproducing apparatus A. As an alternative, the setting content file is recorded in the medium reproducing apparatus MP, from which the content data reproducing apparatus A reads the setting content file at the time of determining the setting content file. Further, the setting file may be configured of an IC card such as SIM (subscriber identity module) or an external memory such as an XD card (registered trade name) or uploaded to the server on a network.

Furthermore, the content data reproducing apparatus A according to this embodiment is so configured that the setting content file generated by executing the setting registration process is added to the recording unit 6. In the case where the setting content file corresponding to the medium is recorded already in the recording unit 6, however, the system control unit 5 may update the setting content file by a new parameter, and overwrite the updated setting content file on the recorded setting content file.

By employing this configuration, the number of the setting content files to be recorded in the recording unit 6 is reduced and therefore the memory capacity of the recording unit 6 can be saved

Further, this embodiment employs a configuration in which the content data reproducing apparatus A includes a D/A converter 9 and an amplifier 10 so that the audio data input from the audio processing unit 4 are D/A converted, amplified by the amplifier 10 and output to the speaker S. These component parts, however, may be replaced by a PCM/PWM modulator and a D-class amplifier.

Furthermore, according to this embodiment, the content data reproducing apparatus A is so configured that the identification data read from the medium are recorded with corresponding setting content files, and the setting of each apparatus is changed based on the setting content file recorded with corresponding identification data for the medium having recorded therein the content data to be reproduced. As an alternative, a configuration including a recording medium for recording a program to specify the processing operation and a computer to read the program may be employed, in which the processing operation similar to the one described above can be executed by the computer reading the program.

### [1.3] Modifications of First Embodiment

(1) First Modification

The content data reproducing apparatus A according to the embodiment described above employs a configuration in which all the parameters are set on the setting screen. Some parameters such as the volume setting parameter, however, are not necessarily set on the setting screen. Instead, a key for setting a predetermined parameter may be included in the instruction input unit 8 and the remote controller, so that when the key is depressed, the parameter is set while at the same time being stored in a RAM, and upon depression of another predetermined key in the instruction input unit 8, the setting content file is generated based on the parameter stored in the RAM.

(2) Second Modification

The content data reproducing apparatus A according to the aforementioned embodiment employs a configuration in which in response to the input operation on the instruction input unit 8 or the remote controller to store a setting content, a setting file corresponding to the set parameter is generated and recorded in the recording unit 6.

As an alternative, the setting change made on the setting screen during the reproduction of the content data recorded in the medium or especially the change in the volume setting parameter, the brightness setting parameter or the contrast setting parameter described above is stored in the RAM, not shown, of the content data reproducing apparatus A, so that the setting content file is generated at a predetermined timing and recorded with a corresponding identification data. The timing of generating the setting content file is arbitrary. For example, the setting content file may be generated (a) at the time of stopping the reproduction of the content data, (b) at the time of power off, or (c) at the time of retrieving the medium from the medium reproducing apparatus MP.

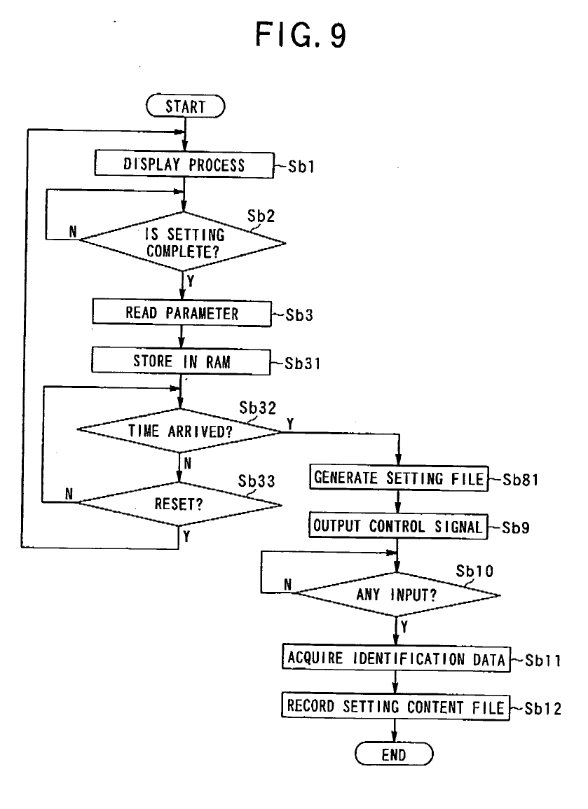

In the case where this method is employed, the system control unit 5 is required to execute the process shown in FIG. 9 as the setting registration process. Incidentally, in FIG. 9, similar steps to those in FIG. 7 are designated by the same reference numerals, respectively.

First in this process, the system control unit 5 executes a process similar to steps Sb1 to Sb3 to read the parameter corresponding to the user setting content from the recording unit 6 and to store the particular parameter in the RAM (step Sb31). The system control unit 5 then determines whether the above-mentioned timing has arrived or not (step Sb32), and upon determination that the timing has yet to arrive (NO at step Sb32), determines whether the input operation for resetting is performed or not (step Sb33).

Upon determination at step Sb33 that the resetting is required (YES), the system control unit 5 repeats the process of steps Sb1 to Sb3 and Sb31 to Sb33. As a result, the parameters of which the user has changed the setting are sequentially stored in the RAM.

In the case where the determination at step Sb33 is that the resetting is not required, on the other hand, the determination is made at step Sb32, and until the arrival of the timing described above, the process of steps Sb32 and Sb33 is repeated. With the arrival of the timing thereafter, the system control unit 5 determines as YES at step Sb32, and based on the parameters stored in the RAM, generates the setting content file (step Sb8l).

A specific method of generating this setting content file is arbitrary. In the case where the setting content file is generated by employing an example of the method described below, however, the setting content file conforming more with the user taste can be generated. Specifically, the setting content file is generated as follows.

<Principle>

Of all the various parameters stored in the RAM, those corresponding to the latest setting content are described.

<Exception>

With regard to the volume setting parameter, the sharpness setting parameter, the brightness setting parameter and the contrast setting parameter, the average value of the parameters is employed. According to this method, however, the sound volume may be reduced temporarily for some reason, for example, and therefore a time element is taken into account Specifically, each parameter and a corresponding time at which the particular parameter is set are stored in the RAM. Based on the time element and the parameter value, the system control unit 5 calculates the average value of the parameters by time. For example, one hour is set for the volume setting parameter of 10, 30 minutes for the volume setting parameter of 15, 15 minutes for the volume setting parameter of 13, and 15 minutes for the volume setting parameter of 17. In this case, the ratio of each time length to the total time length is 0.5 for one hour, 0.25 for 30 minutes and 0.125 for 15 minutes. In such a case, therefore, the system control unit 5 calculates the value of 12.5 as an average time of the volume setting parameters, and as a value of the parameter nearest to the calculation result, 13 is set (by rounding off).

Upon complete generation of the setting content file as the result of execution of the above-mentioned process, the system control unit 5 executes the process of steps Sb9 to Sb12 shown in FIG. 7 and records the particular setting content file with a corresponding identification data.

In the case where this configuration is employed, the setting content file with the corresponding identification data can be recorded in the recording unit 6 without the input operation on the part of the user to record the setting content file. Thus, the input operation by the user is simplified for an improved user operability.

### [2] Second Embodiment

The content data reproducing system S according to this embodiment is implemented with a similar configuration to the first embodiment shown in FIG. 1. Unless otherwise specified, therefore, each component element shown in FIG. 1 has the same function and performs the same operation as the corresponding component element of the first embodiment.

Even in the case where the same content data recorded in the same medium are reproduced, the volume of the sound output from the speaker S or the luminance and the brightness of the whole image at the video output of the monitor MN are desirably differentiated between daytime and nighttime. In the content data reproducing apparatus A according to this embodiment, therefore, the user sets the sound volume, luminance or brightness at the time of reproduction of the content data. Then, the volume setting parameter, the brightness setting parameter and the contrast setting parameter corresponding to specific setting content are stored in the RAM not shown. In the process, the system control unit 5 stores in the RAM the time zone for reproduction of the content data, i e. the time zone from reproduction start to reproduction end.

Then, the system control unit 5 generates the setting content file describing these parameters and the reproduction time zone at a predetermined timing. In the case where the parameter is changed during the reproduction, any parameter value can be set arbitrarily. For example, as in the second modification described above, the average time is calculated and the result of calculation is described in the setting content file.

The setting content file may be generated at an arbitrary time. As a first example, the timing may be set at the time of performing a predetermined input operation on the instruction input unit 8. As another example, as in the second modification described above, the setting content file may be generated (a) at the time of stopping the reproduction of the content data, (b) at the time of power off, or (3) at the time of retrieving the medium from the medium reproducing apparatus MP.

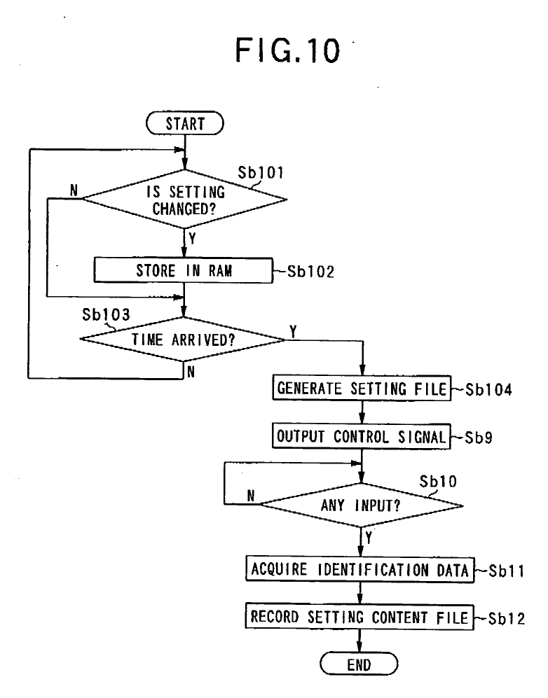

The process executed by the system control unit 5 to generate the setting content file in the content data reproducing apparatus A according to this embodiment is shown in FIG. 10. As shown in FIG. 10, the system control unit 5 monitors the control signal supplied from the instruction input unit 8 or the remote control light receiving unit 7, and determines whether the user has issued an instruction to change the setting of the sound volume or the like or not (step Sb101). In the case where the determination is NO, i.e. in the case where the user has not performed the input operation to change the parameters, the system control unit 5 determines whether the particular timing has arrived or not without executing the process of step Sb102 (step Sb103), and repeats the process of steps Sb101 to Sb103 until the arrival of the timing.

Upon the input operation by the user on the instruction input unit 8 or the like to change the parameter, on the other hand, the system control unit 5 determines as YES at step Sb101. In accordance with the input operation, the parameters such as the volume setting parameter are changed and the parameters thus changed, with a corresponding current time, are stored in the RAM (step Sb102), followed by determining whether the timing has arrived or not (step Sb103).

After that, with the arrival of the generation timing, the system control unit 5 determines as YES at step Sb103, and generates the setting content file (step Sb104). In the process, the system control unit 5 generates the setting content file based on the time at which the parameters and the content data stored in the RAM are reproduced.

Once the setting content file is generated in this way, the system control unit 5 executes a similar process to steps Sb9 to Sb12 shown in FIG. 7, so that the setting content file is recorded with a corresponding identification data.

With the setting content file recorded in this way, assume that an event such as Event 1 described above occurs. Then, the system control unit 5 searches the setting content file based on the current time and the identification data. In the case where the result of search shows that the setting content files corresponding to the identification data contain a setting content file describing the set time zone including the current time, the system control unit 5 changes the setting of each unit based on the particular setting content file. In the case where there exists no setting content file describing the set time zone including the current time, on the other hand, the system control unit 5 sets each unit based on a default parameter.

As described above, in the content data reproducing apparatus A according to this embodiment, the system control unit 5 generates a setting content file, if any, containing at least the time zone during which the particular setting content file is to be used, and upon determination that the identification data is recorded in the recording unit 6, compares the reproduction time with the time zone contained in the setting content file as data corresponding to the identification data. In the case where the reproduction time is contained in the time zone, the content data is reproduced based on the setting content file.

With this configuration, assume that the content data is reproduced during the time zone contained in the setting content file. Then, the content data is reproduced by the setting based on the corresponding setting content file. Even in the case where the content data is reproduced during night time, therefore, the setting is automatically changed without resetting the parameters such as sound volume, luminance and brightness. Thus, the content data can be reproduced by optimum setting at each time.

According to this embodiment, the system control unit 5 is so configured that in the absence of the setting content file describing the set time zone containing the current time, each unit is set based on the parameters set at default. As an alternative, the setting content file generated by a similar process to the first embodiment described above is also recorded in the recording unit 6, and in the absence of the setting content file describing the setting time zone. corresponding to the reproduction time, each unit is set based on the particular setting content file. In this case, the setting content file is generated by a similar method to the first embodiment.

The present invention is not confined to the configurations listed in the foregoing embodiments, but it is easily understood that the person skilled in the art can modify such configurations into various other modes, within the scope of the present invention described in the claims.

The entire disclosure of Japanese Patent Application No. 2004-101112 filed on Mar. 30, 2004 including the specification, claims, drawings and summary is incorporated herein by reference in its entirety.

1. A content data reproducing apparatus comprising:
a reproducing device which acquires the content data with a plurality of unit data arranged in time series from a recording medium and reproduce the content data;
an identification device which identifies a recording medium to be reproduced, based on at least selected one of the first and last recording addresses of predetermined unit data in the recording medium at the time of reproducing the content data;
an acquisition device which acquires the setting information for reproduction of the content data; and
a holding device which holds the acquired setting information with the corresponding recording address for the recording medium, wherein
the reproducing device acquires the setting information corresponding to the recording medium from the holding device based on the identification result in the identification device at the time of the second and subsequent reproduction sessions of the content data, and reproduces the content data based on the setting information.

2. A content data reproducing apparatus according to claim 1, wherein
the acquisition device acquires the setting information corresponding to the setting content for at least selected one of sound quality and image quality at the time of reproducing the content data.

3. A content data reproducing apparatus according to claim 1, wherein
the reproducing device further includes;
a setting changing device which changes the setting for reproduction of an external equipment based on the setting information at the time of reproducing the content data; and
an output device which outputs the content data to be reproduced to the external equipment.

4. A content data reproducing apparatus according to claim 1, wherein
the holding device holds a plurality of setting information indicating different setting contents with the corresponding recording addresses, and wherein
the reproducing device acquires one setting information designated by the user and reproduces the content data based on the setting information in the case where a plurality of setting information are held as data corresponding to the recording addresses.

5. A content data reproducing apparatus according to claim 1, wherein
the acquisition device acquires the setting information including at least the time zone during which the setting information is to be used, and wherein
the reproducing device compares the reproduction time with the time zone included in the setting information recorded with a corresponding recording address, and in the case where the reproduction time is included in the time zone, the content data is reproduced based on the setting information.

6. A content data reproducing system comprising a content data reproducing apparatus which acquires the content data with a plurality of unit data arranged in time series from a recording medium and reproduce the content data, and an external equipment connected to the content data reproducing apparatus, the content data reproducing apparatus including:
a reproducing device which reproduces the content data;
an identification device which identifies a recording medium to be reproduced, based on at least selected one of the first and last recording addresses of predetermined unit data in the recording medium at the time of reproducing the content data;
an acquisition device which acquires the setting information for reproduction of the content data; and
a holding device which holds the acquired setting information with the corresponding recording address for the recording medium, wherein
the reproducing device acquires the setting information corresponding to the recording medium from the holding device based on the identification result in the identification device at the time of the second and subsequent reproduction sessions of the content data, and reproduces the content data based on the setting information while at the same time changing the setting for reproduction of the external equipment based on the setting information.

7. A content data reproducing program readably recorded in a medium or a computer, the content data program is executed by a computer to acquire the content data with a plurality of unit data arranged in time series from a recording medium and reproduce the content data, the program demonstrating function comprising steps of:
identifing a recording medium to be reproduced, based on at least selected one of the first and last recording addresses of predetermined unit data in the recording medium at the time of reproducing the content data;
acquiring the setting information for reproduction of the content data;
holding the acquired setting information with the corresponding recording address for the recording medium; and
acquiring the setting information corresponding to the recording medium based on the identification result the time of the second and subsequent reproduction sessions of the content data, and reproducing the content data based on the setting information.
